(19) United States
(12) Patent Application Publication
(10) Pub. No.: US 2022/0315032 A1
(43) Pub. Date: Oct. 6, 2022

(54) REMOTE ASSISTANCE DEVICE AND REMOTE ASSISTANCE METHOD

(71) Applicant: Woven Planet Holdings, Inc., Tokyo (JP)

(72) Inventor: Ryo IGARASHI, Chofu-shi (JP)

(73) Assignee: Woven Planet Holdings, Inc., Tokyo (JP)

(21) Appl. No.: 17/710,223

(22) Filed: Mar. 31, 2022

(30) Foreign Application Priority Data
Apr. 6, 2021 (JP) 2021-064869

(51) Int. Cl. B60W 50/14; B60W 40/08

(52) U.S. Cl. CPC B60W 50/14; B60W 40/08; B60W 2555/20; B60W 2556/10

(57) ABSTRACT

Based on operation history data, a data processing device calculates an expected total number of a request for a remote assistance in a future unit time zone for each driving license classification in vehicles. The operation history data includes data of a unit time zone in which a remote assistance service has been provided and data of the driving license classification of the vehicle by which the remote assistance service has been provided. The data processing device also sets a predetermined number over the expected total number as a total headcount of operators engaged in the remote assistance service in the future unit time zone. The data processing device also determines an operator waiting to perform the remote assistance in the future unit time zone based on the total headcount and the driving license classification in vehicles owned by the operators.

The present application claims priority under 35 U.S.C. § 119 to Japanese Patent Application No. 2021-064869, filed Apr. 6, 2021, the contents of which application are incorporated herein by reference in their entirety.

### TECHNICAL FIELD

The present disclosure relates to a device and a method to remotely assist an operation of a vehicle.

### BACKGROUND

JP2018-77649A disclose a system that provides a remote assistance service of a vehicle. The system in the prior art includes a management facility that performs the remote assistance of the vehicle. In the management facility, more than one operator is waiting for the remote assistance. When a request of the remote assistance is received from the vehicle, the management facility selects from these operators one operator who satisfies a predetermined condition. The predetermined condition includes that the operator corresponds to an operator who performed recent remote assistance service properly, and that the operator corresponds to an operator of which a proficiency and an arousal level are equal to or higher than a reference value.

However, the system in the prior art lacks aspect to predict an operator demand. Thus, if requests of the remote assistance are concentrated, there may be insufficient operators to respond to all of these requests.

In this regard, increasing number of the operator waiting in the management facility may solve this issue. However, if the number of the waiting operator is increased, it creates another problem of increasing employment costs. In addition, even if the number of the waiting operator is increased, the remote assistance service cannot be provided unless the waiting operator has a driving license of the vehicle requesting the remote assistance.

One object of the present disclosure is to provide a technique capable of appropriately securing the number of the operator waiting for an implementation of the remote assistance in view of the driving license of the vehicle in which the request of the remote assistance is expected.

### SUMMARY

A first aspect is a remote assistance device that provides a remote assistance service of a vehicle and has the following features.

The remote assistance device includes a data base and a data processing device. The database stores identification data of operators performing a remote assistance of a vehicle and operation history data of the remote assistance service.

The identification data includes data of driving license classification in vehicles owned by the operators.

The operation history data includes data of a unit time zone in which the remote assistance service has been provided and data of the driving license classification of the vehicle by which the remote assistance service has been provided.

The data processing device is configured to:

based on the operation history data, calculate an expected total number of a request for the remote assistance in a future unit time zone in which the remote assistance service is provided for each driving license classification in vehicles;

set a predetermined number over the expected total number as a total headcount of operators engaged in the remote assistance service in the future unit time zone; and

determine an operator waiting to perform the remote assistance in the future unit time zone based on the total headcount and the driving license classification in vehicles owned by the operators.

A second aspect further has the following features in the first aspect.

The operation history data further includes data of an area segment in which the remote assistance service has been provided.

In the calculation of the expected total number, the data processing is configured to: based on the operation history data, calculate an expected number of the request for the remote assistance in the future unit time zone for each area segment; and

calculate the expected total number by combining the expected number.

A third aspect further has the following features in the first aspect.

The operation history data further includes data of an area segment in which the remote assistance service has been provided and data of a meteorological classification in the area segment.

In the calculation of the expected total number, the data processing is configured to:

based on the operation history data, calculate the expected number of the request for the remote assistance in the future unit time zone for respective combination of the area segment and the meteorological classification; and

calculate the expected total number by combining the expected number.

A fourth aspect further has the following features in the first aspect.

The future unit time zone is a unit time zone corresponding to the unit time zone of a next day of an operation performance day, the operation performance day is a date on which calculation processing of the expected total number and setting processing of the total headcount are executed.

A fifth aspect further has the following features in the first aspect.

The future unit time zone is a unit time zone corresponding to the unit time zone of a day in a next week having common day of the week with an operation performance day, the operation performance day is a date on which calculation processing of the expected total number and setting processing of the total headcount are executed.

A sixth aspect is a remote assistance method to provide a remote assistance service of a vehicle and has the following features.

The remote assistance method comprising the steps of:

executing processing to calculate, based on data of a unit time zone in which the remote assistance service has been provided and data of driving license classification of a vehicle by which the remote assistance service has been provided, an expected total number of request for the remote assistance in future unit time zone for respective driving license classification in vehicles;

executing processing to set a predetermined number over the expected total number as a total headcount of operators engaged in the remote assistance service in the future unit time zone; and

processing to determine an operator waiting to perform a remote assistance in the future unit time zone based on the total headcount and the driving license classification in vehicles owned by operators performing the remote assistance of the vehicle.

According to the first or sixth aspect, the number of the operators waiting for the implementation of the remote assistance in the future unit time zone can be appropriately set in view of the driving license classification in vehicles owned by the operators. Therefore, it is possible to prevent a shortage of the operators responding to the request for the remote assistance in the future unit time zone.

According to the second aspect, it is possible to calculate the expected total number of the request for the remote assistance even if the operation history data contains the data of the area segment in which the remote assistance service has been provided.

According to the third aspect, it is possible to calculate the expected total number of the request for the remote assistance even if the operation history data contains the data of the area segment in which the remote assistance service has been provided and data of the meteorological classification in this area segment.

According to the fourth aspect, the number of the operators waiting for the implementation of the remote assistance in the unit time zone of the next day of the operation performance day can be appropriately set in view of the driving license classification in vehicles owned by the operators.

According to the fifth aspect, the number of the operators waiting for the implementation of the remote assistance in the unit time zone of the day in the next week having common day of the week with an operation performance day can be appropriately set in view of the driving license classification in vehicles owned by the operators.

### BRIEF DESCRIPTION OF DRAWINGS

FIG. 1 is a conceptual diagram of a remote assistance service;

FIG. 2 is a diagram showing a configuration example of a remote assistance device shown in FIG. 1;

FIG. 3 is a diagram showing a configuration example of operation history data;

FIG. 4 is a diagram showing an example to set area segments;

FIG. 5 is a diagram showing another configuration example of operation history data;

FIG. 6 is a diagram explaining an example of a future unit time zone;

FIG. 7 is a diagram explaining another example of the future unit time zone; and

FIG. 8 is a flowchart showing a flow of processing example executed by a data processing device (a processor).

### DESCRIPTION OF EMBODIMENT

Hereinafter, an embodiment of a remote assistance system and a remote assistance method according to present disclosure will be described reference to the drawings. Note that the remote assistance method according to the embodiment is realized by computer processing executed in the remote assistance system according to the embodiment. In the drawings, the same or corresponding portions are denoted by the same sign, and descriptions to the portions are simplified or omitted.

### 1. Remote Assistance Service

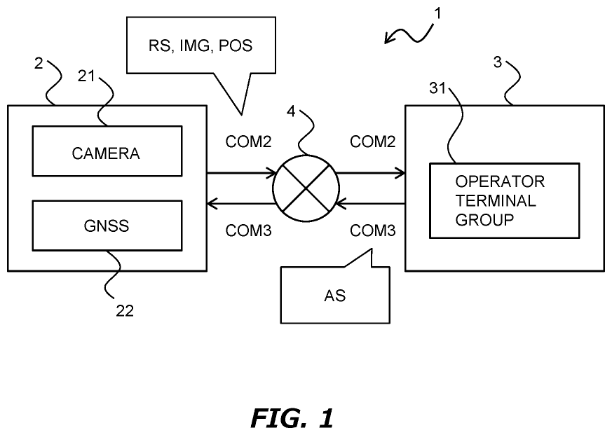

A remote assistance device according to the embodiment constitutes part of a system for performing a remote assistance service of a vehicle. FIG. 1 is a conceptual diagram of the remote assistance service. The system 1 shown in FIG. 1 includes a vehicle 2 that is an object of the remote assistance service, and a remote assistance device 3 that provides the remote assistance service. A communication between the vehicle 2 and the remote assistance device 3 is performed via a network 4. In this communication, communication data COM2 is transmitted from the vehicle 2 to the remote assistance device 3. On the other hand, communication data COM3 is transmitted from the remote assistance device 3 to the vehicle 2.

Examples of the vehicle 2 include a vehicle in which an internal combustion engine such as a diesel engine or a gasoline engine is used as a power source, an electronic vehicle in which an electric motor is used as the power source, or a hybrid vehicle including the internal combustion engine and the electric motor. The electric motor is driven by a battery such as a secondary cell, a hydrogen cell, a metallic fuel cell, and an alcohol fuel cell.

The vehicle 2 runs by an operation of a driver of the vehicle 2. The operation of the vehicle 2 may be performed by a control system mounted on the vehicle 2. This control system, for example, executes vehicle control to support a manual driving by the driver or executes vehicle control to perform automated driving of the vehicle 2. The former is generically referred to as travel assist control, and the latter is generically referred to as automated driving control. When the driver or the control system determines that the remote assistance is required, a request signal RS to request the remote assistance is transmitted to the remote assistance device 3. The request signal RS is included in the communication data COM2.

The vehicle 2 includes a camera 21. The camera 21 capture an image (a moving image) of surrounding environment of the vehicle 2. The camera 21 includes at least one camera provided for capturing the image at least in front of the vehicle 2. The camera 21 for capturing the front image is, for example, on a back of a windshield of the vehicle 2. The image data IMG acquired by the camera 21 is typically moving image data. However, the image data IMG may be still image data. The image data IMG is included in the communication data COM2.

The vehicle 2 also includes a GNSS (Global Navigation Satellite System) receiver 22. The GNSS receiver 22 receives signals from three or more artificial satellites. The GNSS receiver 22 generates position and posture data POS of the vehicle 2 based on this received signals. The position and posture data POS is also included in the communication data COM2.

When the remote assistance device 3 receives the request signal RS, it performs the remote assistance of the running of the vehicle 2 that transmits the request signal RS. This remote assistance is performed by an operator residing in a remote facility. More than one operator resides in the remote facility, of which one is responsible for the remote assistance of the vehicle 2. The method to select one operator from two or more operators is not particularly limited, and a known method is applied. An operator terminal group 31 shown in FIG. 1 is a generic name of terminals (hereinafter also referred to as “operator terminals”) operated by the operators during the remote assistance.

The operator terminal includes, for example, a display, an input device, and a data processing device. The image data IMG is displayed on the display. Based on the image data IMG displayed on the display, the operator understands the surrounding environment of the vehicle 2 and enters a support instruction for the vehicle 2. The data processing device generates a support signal AS based on this support instruction and transmits it to the vehicle 2. The support signal AS is included in the communication data COM3.

Examples of the remote assistance by the operator include a cognitive assistance and a decision assistance. Here, consider a case where automated driving control is performed by a control system of the vehicle 2. When sunlight hits a traffic light in front of the vehicle 2, an accuracy in recognition of a lighting condition of a light emitting section of the traffic light is lowered. When the lighting condition cannot be recognized, it is also difficult to determine what action should be performed at what timing. In such a case, the recognition assistance of the lighting condition is performed and/or the determination assistance of the action of the vehicle 2 based on the lighting condition recognized by the operator is performed.

The remote assistance by the operator also includes a remote operation. In the remote operation, the operator performs a driving operation of the vehicle 2 including at least one operation of a steering, an acceleration, and a deceleration with reference to the image data IMG displayed on the display. In this case, the support signal AS includes a signal indicating a content of the driving operation of the vehicle 2. A control system of the vehicle 2 performs a driving operation of the vehicle 2 including at least one of the steering, the acceleration, and the deceleration in accordance with the support signal AS.

### 2. Remote Assistance Device

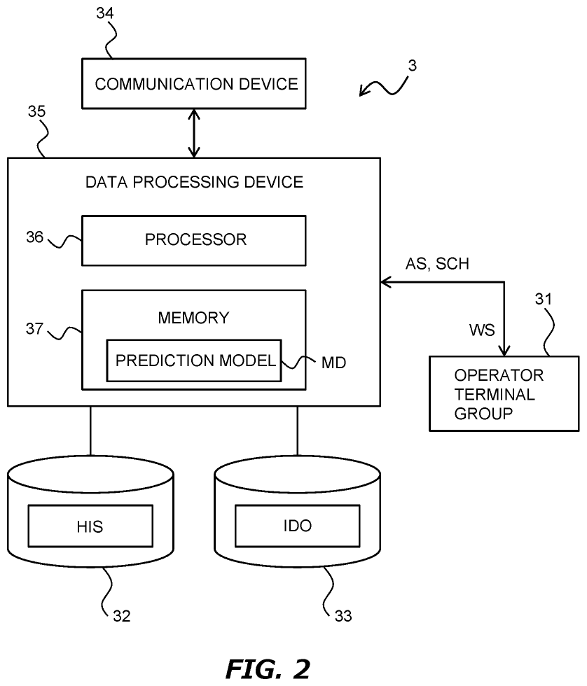

FIG. 2 is a diagram showing a configuration example of the remote assistance device 3 shown in FIG. 1. As shown in FIG. 2, the remote assistance device 3 includes an operator terminal group 31, databases 32 and 33, a communication device 34, and a data processing device 35. The data processing device 35 and the operator terminal group 31 and the databases 32 and 33 are connected via a dedicated network.

### 2-1. Operator Terminal Group 31

The operator terminal group 31 includes two or more operator terminals allocated per operator. The configuration example of the operator terminal is described earlier in the explanation in FIG. 1. The operator terminal transmits the support signal AS to the data processing device 25. The operator terminal may transmit the support signal AS directly to the vehicle 2 without going through the data processing device 25.

The operator terminal transmits schedule data SCH of the operator to the data processing device 25. The schedule data SCH includes data of future unit time zone in which the operator can respond to the remote assistance service. The schedule data SCH may be transmitted to the data processing device 25 without going through the operator terminal. That is, the schedule data SCH may be transmitted to the data processing device 24 through a terminal other than the operator terminal (e.g., a terminal for a general business use of the operator).

### 2-2. Database 32

The data base 32 is a nonvolatile storage medium such as a flash memory or a HDD (Hard Disk Drive). In the database 32, operation history data HIS of the remote assistance service is stored. Examples of the operation history data HIS include data obtained by combining time zone data TZN and driving license classification data SGL in vehicles. For example, the time zone data TZN is composed of data of a unit time zone TM in which the remote assistance service was provided. The driving license classification data SGL is composed of data of a driving license classification in vehicles (e.g., large, medium, semi-medium, and normal) to which the remote assistance service was provided.

Another examples of the operation history data HIS includes data in which a combination of the two types of data TZN and SGL described above is further combined with area segment data SGA to which the remote assistance service was provided. For example, the area segment data SGA is composed of data of an area segment AR in which the remote assistance service was provided.

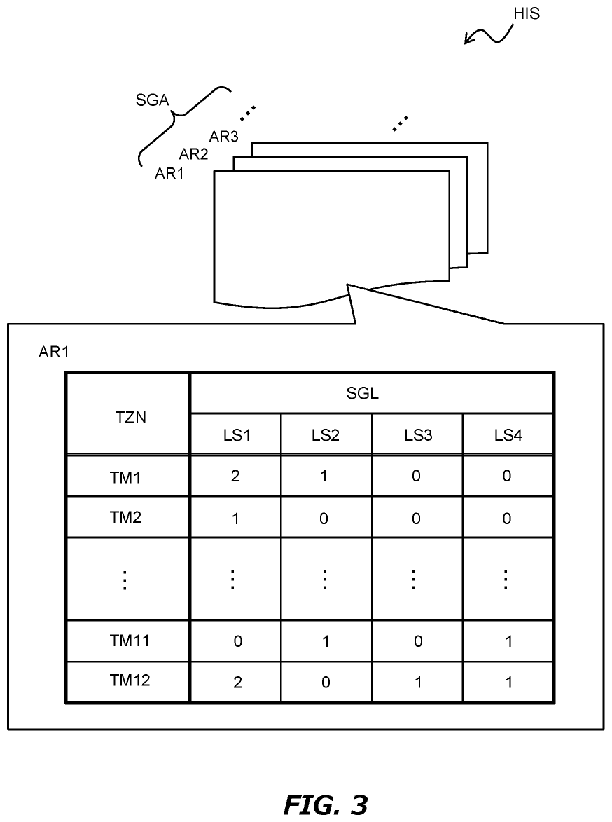

FIG. 3 is a diagram showing a configuration example of data when the operation history data HIS is composed of the combination of the three types of data TZN, SGL, and SGA. In FIG. 3, a data table of an area segment AR1 in which unit time zones TM1 to TM12 and the driving license classifications LS1 to LS4 are combined is depicted. For example, the unit time zones TM1 to TM12 are set by dividing a standard time zone (e.g., 24 hours) by two-hour basis. The standard time zone and number of divisions are not limited to this case. The driving license classifications LS1 to LS4 are examples of the driving license classification of a vehicle assumed as the object of the remote assistance service.

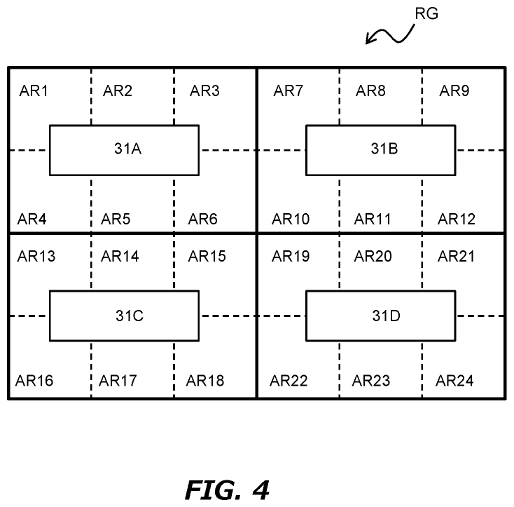

The data table having the same configuration as that of the area segment AR1 is also formed in area segments AR2, AR3, . . . . For example, these area segments AR1, AR2, AR3, . . . are set by dividing an area on which the remote assistance service is supposed to be provided by a predetermined area basis (e.g., 80 km² basis). FIG. 4 is a diagram illustrating an example to set the area segments AR. In the example shown in FIG. 4, a region RG on which the remote assistance service is supposed to be provided is divided into meshes, whereby the area segments AR1 to AR24 are set. The respective positions of the area segments AR1 to AR24 are specified by, for example, a latitude and a longitude.

FIG. 4 also shows an example of areas for which the operator terminal groups 31A to 31D are assigned. This assigned area is set based on the position of the vehicle 2 when the remote assistance device 3 receives the request signal RS from the vehicle 2. Specifically, when the position of the vehicle 2 is within the area segments AR1 to AR6, any one terminal belonging to the operator terminal group 31A is assigned to the remote assistance of the said vehicle 2. If the position of the vehicle 2 is within the area segments AR7 to AR12, any one terminal belonging to the operator terminal group 31B is assigned to the remote assistance of the said vehicle 2. The method to set the assigned area is not limited to this example. In addition, the assigned area may not be set.

As still another example of the operation history data HIS includes data in which a combination of the three types of data TZN, SGL and SGA described above is further combined with meteorological classification data. Examples of the meteorological classification data include weather classification data SGW and temperature zone data SGT. For example, the weather classification data SGW is composed of data of a weather classification SW such as sunny, cloudy, rainy and snowy. For example, the temperature zone data SGT is composed of data of a unit temperature zone TP.

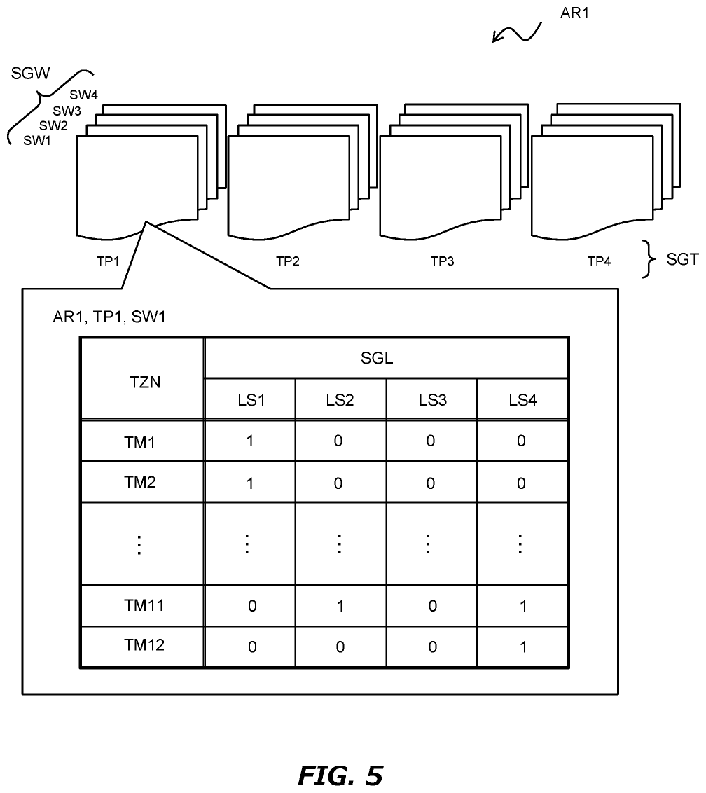

FIG. 5 is a diagram showing a configuration example of data when operation history data HIS is composed of combinations of the above-mentioned five types of data TZN, SGL, SGA, SGW, and SGT. FIG. 5 depicts a data table similar to the area segment AR1 data table described in FIG. 3. Unlike in the example shown in FIG. 3, in the example shown in FIG. 5, the unit time zones TM1 to TM12, driving license classifications LS1 to LS4, a weather classification SW1, and a unit temperature zone TP1 are combined.

Weather classification SW1˜SW4 is an exemplary weather classification SW. The unit temperature zone TP1 to TP4 are examples of the unit temperature zone TP. For example, the unit temperature zones TP1 to TP4 are set by dividing a standard temperature zone (e.g., −5° C. to 35° C.) by 10° C. basis. The standard temperature zone and number of divisions are not limited to this case. Although omitted in FIG. 5, the data tables having the same configuration of that in the area segment AR1 are formed in area segments AR2, AR3,

### 2-3. Database 33

Return to FIG. 2 and continue explaining the configuration example of the remote assistance device 3. The database 33 is a non-volatile storage medium such as a flash memory or an HDD. The identification data IDO of the operators is stored in the data base 33. The identification data IDO includes, for example, data of respective identification number of the operators and data of respective driving license classification in vehicles owned by the operators. This driving license classification corresponds to the driving license classifications LS1 to LS4 described in FIG. 3.

In the present embodiment, it is assumed that driving license classification LS1 is the most significant class and the driving license classification LS4 is the least significant class. The rank of driving license classification indicates the rank in vehicles that the operator can operate. That is, the operator having the highest class LS1 can also operate vehicles in relative lower classes LS2 to LS4. On the other hand, the operator having the lowest class LS4 cannot operate vehicles in relative higher classes LS1 to LS3. The data stored as the identification data IDO is the data of the most significant class that each of the operators have.

### 2-4. Communication Device 34

The communication device 34 wirelessly communicates with a base station of the network 4. Examples of the communication standard of this wireless communication include a mobile communication standard such as 4G, LTE, and 5G. A communication partner of the communication device 34 includes the vehicle 2. In the communication with the vehicle 2, the communication device 34 transmits the support signal AS that was received from the data processing device 35 to the vehicle 2. A communication destination of the communication device 34 may include a server of the weather forecasting data. In the communication with this server, the communication device 34 may receive the weather forecasting data (e.g., forecast data of weather and temperature) in the area on which the remote assistance service is supposed to be provided.

### 2-5. Data Processing Device 35

A data processing device 35 is a computer for processing various data. The data processing device 35 includes at least one processor 36 and at least one memory 37. The processor 36 includes a CPU (Central Processing Unit). The memory 37 is a volatile memory, such as a DDR memory, which develops program used by the processor 36 and temporarily stores various data.

The processor 36 executes processing to calculate an expected total number TNR of a request for the remote assistance in a future unit time zone. The processor 36 also executes processing to set a total headcount TNA of the operators engaged in the remote assistance service in the future unit time zone. The processor 36 further generates a waiting signal WS in the future unit time zone based on the total headcount TNO in this time zone, the identification data IDO, and the scheduled data SCH. Examples of detail contents of the processing executed by the processor 36 will be described later.

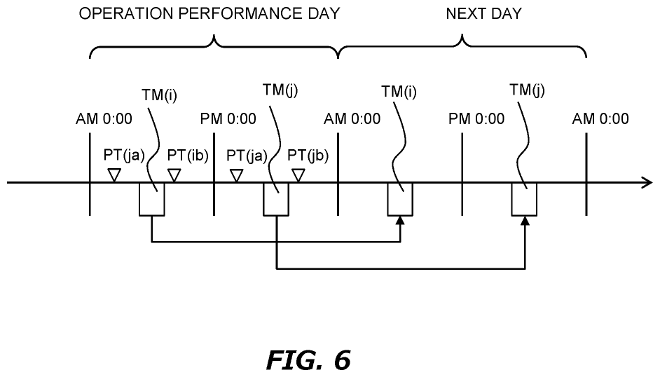

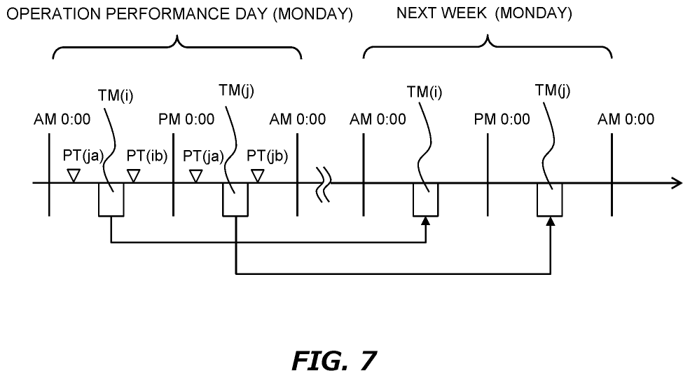

Here, the “future unit time zone” will be described. FIGS. 6 and 7 are diagrams for explaining examples of the future unit time zone. The future unit time zone is set based on a date (hereinafter also referred to as an “operation performance day”) on which the processing to calculate the expected total number TNR and processing to set the total headcount TNO are executed. In FIG. 6, unit time zones TM(i) and TM(j) are shown as examples of the unit time zone TM on the operation performance day. The unit time zone TM(i) belongs to the morning of the operation performance day. The time zone TM(j) belongs to the afternoon of the operation performance day. In the example shown in FIG. 6, the future unit time zone is the unit time zone of next day corresponding to each of the unit time zones TM(i) and TM(j) in the operation performance day.

FIG. 6 also shows examples of timings PT(ia) and PT(ib) at which the processing to calculate the expected total number TNR and processing to set the total headcount TNO are executed in the unit time zone TM(i). The former is earlier than the unit time zone TM(i) of the operation performance day. The latter is later than this unit time zone TM(i). The operation history data HIS in the unit time zone TM(i) of the operation performance day is obtained after the elapse of the unit time zone TM(i). Therefore, when the operation history data HIS of the operation performance day is considered, the respective processing is executed at the timing PT(ib), and otherwise, the processing is executed at the timing PT(ia).

For the same reason, when considering the operation history data HIS of the operation performance day, the processing to calculate the expected total number TNR in the unit time zone TM(j) or the processing to set the total headcount TNO is executed at time PT(jb). Otherwise, the processing to calculate the expected total number TNR in the unit time zone TM(j) or the processing to set the total headcount TNO is executed at the timing PT(ja).

In FIG. 7, as an example of the unit time zone TM in the operation performance day, an example in which the operation performance day is Monday is shown. The future unit time zones are the unit time zones of a day in a next week corresponding to each of the unit time zones TM(i) and TM(j) and having common day of the week with the operation performance day (i.e., next Monday). The explanation of the unit time zones TM(i) and TM(j), and the timings PT(i) and PT(j) is the same as that described in the example shown in FIG. 6.

The various data stored in the memory 37 includes a prediction model MD. The prediction model MD is a computational model for calculating the expected total number TNR. The prediction model MD is constructed by, for example, a multiple regression analysis using data included in the operation history data HIS as its parameters. The processing to construct the prediction model MD is executed at each time when the processing to calculate the total number TNR is executed.

A first example of the parameters that is used for the processing to construct the prediction model MD includes the driving license classification data SGL and the time zone data TZN. A second example of the parameters includes the driving license classification data SGL, the time zone data TZN, and the area segment data SGA. A third example of the parameters include the driving license classification data SGL, the time zone data TZN, the area segment data SGA and the meteorological classification data (i.e., the weather classification data SGW and the temperature zone data SGT).

### 3. Processing Example Executed by the Data Processing Device

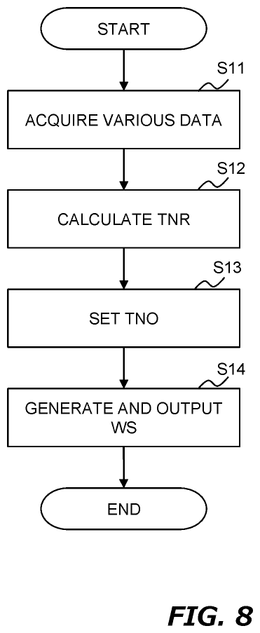

FIG. 8 is a flowchart illustrating a flow of processing example executed by the data processing device 35 (the processor 36). The routine shown in FIG. 8 is repeatedly executed at a predetermined cycle, for example. Note that the predetermined cycle is set in advance according to a cycle to execute the processing to calculate the expected total number TNR and the processing to set the total headcount TNO.

In the routine shown in FIG. 8, first, various data is acquired (step S11). Examples of various data include the operation history data HIS, the identification data IDO and the scheduling data SCH. As the operation history data HIS, for example, data before the operation performance day is extracted. The operation history data HIS may be extracted including data of the current operation performance day. As the schedule data SCH, for example, data after the operation performance day is extracted. If the operator terminal group 31 is fragmented (see FIG. 4), the operation history data HIS, the identification data IDO and the scheduling data SCH are extracted from respective assigned area.

After the execution of the processing in the step S11, the expected total number TNR is calculated (step S12). In the calculation of the expected total number TNR, the processing to construct the prediction model MD is executed. The prediction model MD is constructed, for example, by performing a multiple analysis using the data included in the operation history data HIS extracted in the processing in the step S11 as its parameters.

These parameters include the parameters described in the first to third examples. According to the first example, the prediction model MD in which the future unit time zone is used as an explanatory variable X and the expected total number TNR for each driving license classification SL in this unit time zone is used as an objective variable Y is constructed. According to the second example, the prediction model MD of which the explanatory variable X contains the future unit time zone and the area segment AR, while the objective variable Y contains the expected number NR of the request for each driving license classification SL in the unit time zone and the area segment AR is constructed. According to the third example, the prediction model MD of which the explanatory variable X contains the future unit time zone, the area segment AR and the meteorological classification, while the objective variable Y contains the expected number NR of the request for each driving license classification SL in the unit time zone, the area segment AR and the meteorological classification is constructed.

Once the prediction model MD is constructed, the objective variable Y is calculated by applying the explanatory variable X to this prediction model MD. Note that when the prediction model MD in the third example is used, the weather forecasting data of the date to which the future unit time zone belongs is separately acquired, and the meteorological classification (i.e., the weather classification SW and the unit temperature zone TP) for each of the area segments AR is specified. The specified meteorological classification is used as the explanatory variable X to be assigned to the prediction model MD.

According to the prediction model MD in the first example, the expected total number TNR as the objective variable Y is directly calculated. On the other hand, according to the prediction model MD in the second example, the expected number NR for each area segment AR is calculated as the objective variable Y. According to prediction model MD in the third example, the expected number NR for each area segment AR and meteorological classification is calculated as the objective variable Y. Therefore, when the prediction model MB in the second or third example is used, the expected number NR as the objective variable Y is summed up. Therefore, the expected total number TNR is calculated.

After the execution of the processing of the step S12, the total headcount TNO is set (step S13). The total headcount TNO is set to a predetermined number that exceeds the expected total number TNR calculated in the processing of the step S12 (e.g., TNR plus margin α). The margin α represent the numbers of reserve personnel. The margin α is set, for example, in view of hiring costs for the reserve personnel.

After the execution of the processing of the step S13, the waiting signal WS is generated and outputted (step S14). The waiting signal WS is generated based on the total headcount TNO set by the processing in the step S13 and the identification data IDO and the schedule data SCH acquired by the processing in the step S11. If the operator terminal group 31 is fragmented (see FIG. 4), the waiting signal WS is generated and outputted based on the identification data IDO and the scheduling data SCH extracted from respective assigned area.

As previously described, the identification data IDO includes the highest class of the driving license classification in vehicles owned by the operators. Also, the scheduled data SCH includes data of future unit time zone in which the operator can respond to the remote assistance service. Therefore, according to the identification data IDO and the scheduled data SCH, it is possible to grasp the total headcount TNO that can respond to the remote assistance service in the future unit time zone for each driving license classification.

When generating the waiting signal WS, the operators are allocated in order from the highest driving license class. For example, consider a case where the total headcount TNO of the driving license classification LS1 is NL1. In this case, a predetermined number (NL1 plus a margins β) of the operators of which the most significant class are the driving license classification LS1 are assigned to the remote assistance service. The margins β represent the numbers of the reserve personnel (β<α).

Consider a case where the total headcount TNO of the driving license classification LS2 is NL2. In this case, a predetermined number (NL2 plus a margin γ) of the operators of which the most significant class are the driving license classification LS1 or LS2 are assigned to the remote assistance service. The margins γ represent the numbers of the reserve personnel (γ<α). The allocation technique described above also applies to the driving license classifications LS3 and LS4.

According to the allocation is performed, the operators waiting for an implementation of the remote assistance in the future unit time zone are determined. The waiting signal WS is a signal indicating the future unit time zone during which the operator is needed to wait for the execution of the remote assistance. The waiting signal WS is outputted to the operator terminals allocated to the operators determined by the allocation described above. The waiting signal WS may be transmitted to the terminal other than the operator terminal.

### 4. Effect

According to the embodiment, the expected total number TNR of the request for the remote assistance in the future unit time zone is calculated based on the operation history data HIS comprising driving license classification LS and unit time zone TM data. Then, based on this expected total number TNR, the total headcount TNO of the operators assigned to the remote assistance service in the future unit time zone is set. Then, based on the total headcount TNO and the driving license classification included in the identification data IDO, the operators waiting for the implementation of the remote assistance in the future unit time zone are determined.

As described above, according to the embodiment, the number of the operators waiting for the implementation of the remote assistance in the future unit time zone can be appropriately set in view of the driving license classification included in the identification data IDO. Therefore, it is possible to prevent a shortage of the operators responding to the request for the remote assistance in the future unit time zone. This leads to the promotion of the use of remote assistance service.

What is claimed is:

1. A remote assistance device configured to provide a remote assistance service of a vehicle, comprising:
a database in which identification data of operators performing a remote assistance of a vehicle and operation history data of the remote assistance service is stored; and
a data processing device,
wherein the identification data includes data of driving license classification in vehicles owned by the operators,
wherein the operation history data includes data of a unit time zone in which the remote assistance service has been provided and data of the driving license classification of the vehicle by which the remote assistance service has been provided,
wherein the data processing device is configured to:
based on the operation history data, calculate an expected total number of a request for the remote assistance in a future unit time zone in which the remote assistance service is provided for each driving license classification in vehicles;
set a predetermined number over the expected total number as a total headcount of operators engaged in the remote assistance service in the future unit time zone; and
determine an operator waiting to perform the remote assistance in the future unit time zone based on the total headcount and the driving license classification in vehicles owned by the operators.

2. The remote assistance device according to claim 1,
wherein the operation history data further includes data of an area segment in which the remote assistance service has been provided,
wherein, in the calculation of the expected total number, the data processing is configured to:
based on the operation history data, calculate an expected number of the request for the remote assistance in the future unit time zone for each area segment; and
calculate the expected total number by combining the expected number.

3. The remote assistance device according to claim 1,
wherein the operation history data further includes data of an area segment in which the remote assistance service has been provided and data of a meteorological classification in the area segment,
wherein, in the calculation of the expected total number, the data processing is configured to:
based on the operation history data, calculate the expected number of the request for the remote assistance in the future unit time zone for respective combination of the area segment and the meteorological classification; and
calculate the expected total number by combining the expected number.

4. The remote assistance device according to claim 1,
wherein the future unit time zone is a unit time zone corresponding to the unit time zone of a next day of an operation performance day, the operation performance day is a date on which calculation processing of the expected total number and setting processing of the total headcount are executed.

5. The remote assistance device according to claim 1,
wherein the future unit time zone is a unit time zone corresponding to the unit time zone of a day in a next week having common day of the week with an operation performance day, the operation performance day is a date on which calculation processing of the expected total number and setting processing of the total headcount are executed.

6. A remote assistance method to provide a remote assistance service of a vehicle, the method comprising the steps of:
executing processing to calculate, based on data of a unit time zone in which the remote assistance service has been provided and data of driving license classification of a vehicle by which the remote assistance service has been provided, an expected total number of request for the remote assistance in future unit time zone for respective driving license classification in vehicles;
executing processing to set a predetermined number over the expected total number as a total headcount of operators engaged in the remote assistance service in the future unit time zone; and
processing to determine an operator waiting to perform a remote assistance in the future unit time zone based on the total headcount and the driving license classification in vehicles owned by operators performing the remote assistance of the vehicle.
